(19) United States
(12) Patent Application Publication
(10) Pub. No.: US 2022/0011730 A1
(43) Pub. Date: Jan. 13, 2022

(54) Method for Simulation of Operating/Component Conditions of Plants, Especially Power Plants

(71) Applicant: BTB Jansky GmbH, Leonberg (DE)

(72) Inventors: Magnus Langenstein, Ditzingen (DE); Arjan van Mulukom, Utrecht (NL)

(21) Appl. No.: 17/373,807

(22) Filed: Jul. 13, 2021

(30) Foreign Application Priority Data
Jul. 13, 2020 (DE) 10 2020 004 277.5

(51) Int. Cl. G05B 17/02; G06F 30/20

(52) U.S. Cl. CPC G05B 17/02; G06F 2119/02; G06F 30/20

(57) ABSTRACT

In a method for simulation of operation/component states of a plant, process data of the plant components are measured and recorded, including associated uncertainties of the process data. Subsequently, the process data including the associated uncertainties are subjected to a validation to produce validated process data. Based on the validated process data, component characteristics with uncertainty values in accordance with the validated process data are determined. The method can be used in a power plant.

### BACKGROUND OF THE INVENTION

The invention concerns a method for simulation of operating/component conditions of plants, especially power plants, in which component characteristics and process data of plant facilities are combined with each other and linked with measured values of the plant.

Simulation programs are utilized in power plant technology inter alia in order to run so-called “what-if” scenarios. For example, the plant operator would like to know which plant efficiency is present when the power plant is operated only at 70% partial load instead of at full load, without having to operate the plant actually at such an output. By means of the simulation program, a corresponding simulation model is created and different scenarios are run through.

The conventional simulation programs employ constant preset values e.g. for pressure, temperature, mass flows, and component libraries in which the specifications of the component manufacturers are stored. Such components are, for example, pumps, turbines, heat exchangers, condensers, generators and the like. These components are connected to each other by means of connections, the so-called streams, in the simulation model. These streams correspond in general to real pipelines which produce the connection between the components. In the pipelines, a medium such as e.g. water, steam or gas is present. The sensors which are installed in these pipelines, which provide measured values such as temperature, pressure, mass flow, record the thermodynamic state of the medium.

The components are characterized by component characteristics which are made available by the manufacturers of the components. These component characteristics, in general characteristic lines and characteristic maps, characterize the theoretical actual state (new state) of the components derived from calculations.

Since the component characteristics of the manufacturers represent only the ideal state or the configuration state of the components, they do not correctly represent the state of the plant at any time. Since the employed preset values (in general process data such as pressure, temperature or mass flows) and the component characteristics of the manufacturers represent only absolute values, the plant operator has the problem that he obtains only absolute values as a simulation result.

The invention has the object to configure the method of the aforementioned kind in such a way that the plant operator obtains reliable and sound results in his simulation calculation with associated uncertainties.

### SUMMARY OF THE INVENTION

This object is solved according to the invention for the method of the aforementioned kind in that the process data of the plant components are measured and in this context the respective uncertainties of the process data are recorded, that the process data including their uncertainties are subjected to a validation, e.g. according to VDI 2048, and that with these validated process data the component characteristics are determined which are provided in accordance with the process data with uncertainties and are validated e.g. according to VDI 2048.

In the method according to the invention, in a simple manner the actual state of the plant is taken into consideration. For this purpose, first the measured process data and the associated uncertainties of these measured values are recorded. The measured values are, for example, temperature, pressure, volume flows, valve positions, and the like. The determined and recorded measured values including the associated uncertainties are subjected to a mathematical statistical method which is described, for example, in the standard VDI 2048. The procedure according to VDI 2048 is known and is therefore not explained here in more detail. With the validated process data, the validated component characteristics are determined which already take into account the aging state, wear state, abrasion state, and the like of the plant components, which is advantageous for the plant operator. Since the process data have correlated therewith the uncertainties, the validated component characteristics which are determined on this basis also contain these uncertainties due to the error propagation.

In the method according to the invention, measured values and component characteristics are taken into account together with their uncertainties. Constant preset values can be taken into account with their uncertainties as well as without their uncertainties. When closing mass balances, energy balances, and materials balances, the most probable values for the process and their uncertainties are calculated.

Taking into account measured values, preset values, and component characteristics, a quality-assured simulation and calculation of what-if scenarios including determination of result uncertainties can be realized.

Advantageously, for determining enthalpies, steam tables with uncertainties according to international standard are utilized so that also in this case reliable and sound results are obtained.

The subject matter of the invention results not only from the subject matter of the individual claims but also from all features and specifications disclosed in the drawings and the description. Even though they are not subject matter of the claims, they are considered important to the invention provided that they are, individually or in combination, novel in relation to the prior art.

Further features of the invention result from the further claims, the description, and the drawings.

### BRIEF DESCRIPTION OF THE DRAWING

The invention will be explained in more detail with the aid of the embodiments illustrated in the drawings.

FIG. 1 is a schematic illustration of the procedure for optimizing an energy-technological and process-technological plant based on a data validation according to VDI 2048.

FIG. 2 is a schematic of a simulation concept according to the invention.

FIG. 3 is an example of component characteristics that are used for the simulation method according to the invention.

FIG. 4 is another example of component characteristics that are used for the simulation method according to the invention.

FIG. 5 is yet another example of component characteristics used for the simulation method according to the invention.

### DESCRIPTION OF THE PREFERRED EMBODIMENTS

With the method to be described in the following, it is possible to carry out a reliable power plant simulation taking into account different power plant parameters that take into account very different aspects such as aging, wear, abrasion and the like of plant parts.

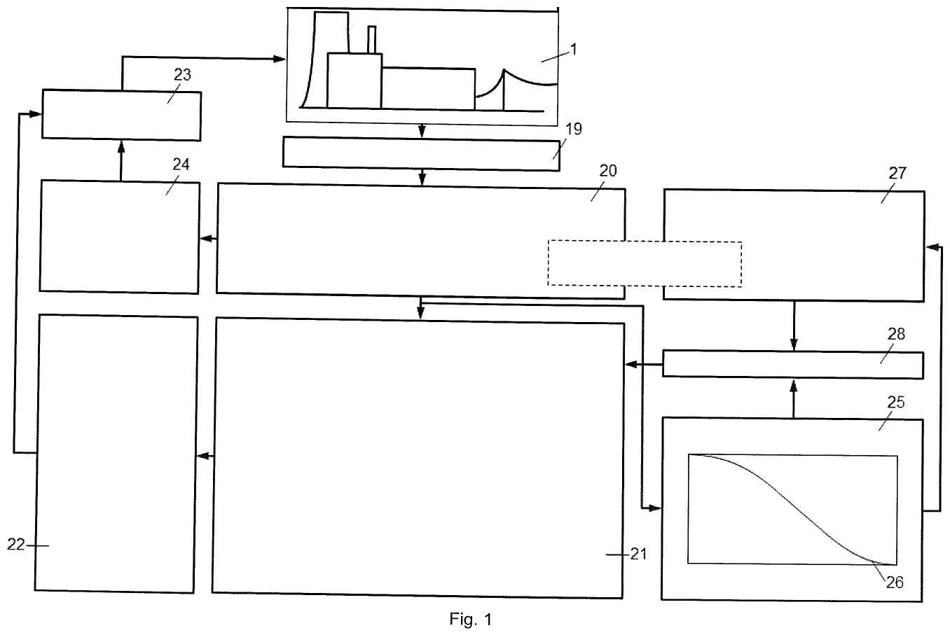

FIG. 1 shows in schematic illustration recording and analyzing various parameters of a plant 1 which is, for example, a power plant. The plant 1 has different plant components such as pumps, turbines, condensers, generators, valves, conduits, and the like, which are not illustrated in detail in FIG. 1.

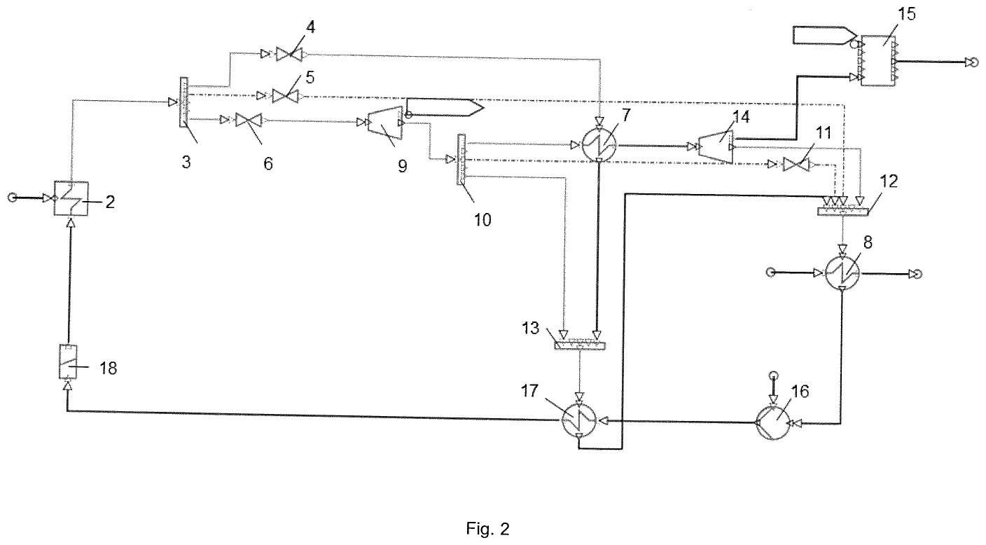

FIG. 2 shows in schematic illustration a simulation model of the plant 1 based on which the components of such a power plant will be explained. As an example, a steam generator 2 is provided that is connected to a distributor 3. It connects the steam generator 2 by means of valves 4, 5 to a water separator 7 and a condenser 8 as well as by means of a valve 6 to a turbine 9. The turbine 9 is connected by means of a further distributor 10 to the water separator 7, by a valve 11 to a distributor 12, and is connected to a distributor 13.

The water separator 7 is arranged upstream of the turbine 14. The condenser 8 is connected to the suction side of a pump 16 that has at its pressure side a pre-heater 17. A heat exchanger 18 is arranged between the pre-heater 17 and the steam generator 2.

The water separator 7 is not only connected to the downstream turbine 14 but also connectable to the distributor 13. The water separator 7 is also connected thereto.

The condenser 8 ensures that the steam is converted to liquid. The liquid is supplied by the pump 16 through the pre-heater 17 to the steam generator 2 which converts the liquid to steam again. The liquid/steam flows pass via distributor 3 and valve 4 to the water separator 7. Another portion of the liquid/steam flows passes through the valve 6, the turbine 9, and the distributor 10 to the distributor 13. In the water separator 7, the liquid/steam flow is divided into a liquid flow and into a steam flow. The liquid flow passes to the distributor 13 while the pure steam flow is supplied to the turbine 14.

At the distributor 13, the liquid flow and the liquid/steam flow are supplied to the pre-heater 17 which converts the steam again into liquid. The liquid is supplied in the described manner through the pump 16 to the steam generator 2.

The configuration of the power plant 1 as described with the aid of FIG. 2 and its function are to be understood only as an example. A limitation to such a configuration and function is not intended.

In the following, it will be described how an energy-technological and process-technological plant 1, such as the power plant, is optimized based on a validation of data and component characteristics in conformity with VDI 2048.

When the standard VDI 2048 is mentioned here, this does not preclude, of course, that also other standards can be utilized for validation.

In a validation, an over-determined equation system is solved. In this context, the number of equations is larger than the number of unknowns. This means that so-called redundancies are present (redundancy>0). A complete value is always employed, i.e., “complete value=absolute value±associated uncertainty”. By means of the error propagation based on this a complete result is determined, i.e., “complete result=absolute value±associated uncertainty”.

The component characteristics are quality-assured characteristics lines that describe the actual state of the plant. The characteristics lines are established such that they include also uncertainties from the error propagation as well as effects such as aging, wear, abrasion of the plant parts, and the like.

The process data of the plant are formed such that the described uncertainties (tolerances) are encompassed. These process data encompass all (even redundant) information including their uncertainties. The steam tables which are used in such plants also take into account such uncertainties.

In step 19, the process data (also referred to as raw data or measured data) of the plant 1 are measured which, for example, may be temperature values, pressure values, volume flows, valve positions and the like. The data of step 19 are subjected in step 20 to a data validation according to VDI 2048. The validated measured values and data are recorded or stored and visualized in step 21. In this context, not only the validated values can be captured and observed but also specifications in regard to the point in time of the measurement, the date of the measurement, the location of the measurement and the like can be recorded.

This can be realized, for example, in the form of tables, process flow diagrams and the like. Monitoring or storage can be done on external servers but also in the cloud, for example.

Monitoring of the values can provide the operator of the plant 1 with information in regard to a non-optimal operation of the plant 1, which is done in step 22. The validated data can provide information in regard to non-optimal operation, for example, in respect to internal or external leakages in the plant 1. Also, the plant operator may receive information in regard to power losses, faulty or shifting measurements and the like. These indications are used for adjusting the plant 1 anew in an optimizing step 23 such that the determined faults are corrected. Should it be found in the process data validation in step 20 that systemic deviations occur, then in step 24 corresponding corrective factors can be determined which are to be taken into account in the optimizing step 23.

Based on the validated process data (step 20), in step 25 the component characteristics are determined. FIG. 1 shows in an exemplary manner a characteristic line 26 as a component characteristic. Since this characteristic line has been determined based on the process data validated according to VDI 2048, it is provided with an uncertainty. The component characteristics thus take into consideration aging symptoms, wear symptoms, abrasion symptoms and the like as well as also uncertainties from the error propagation.

In the what-if analysis (step 27), the component characteristics 26 which are generated in step 25 and the values calculated in the analysis (step 28) are determined. They are recorded or stored as reference values and are visualized in step 21.

A decisive advantage of the here described new method is that the model for process data validation according to VDI 2048 as well as the model for simulation of what-if scenarios are identical. Accordingly, an important level of quality assurance is fulfilled due to the same model.

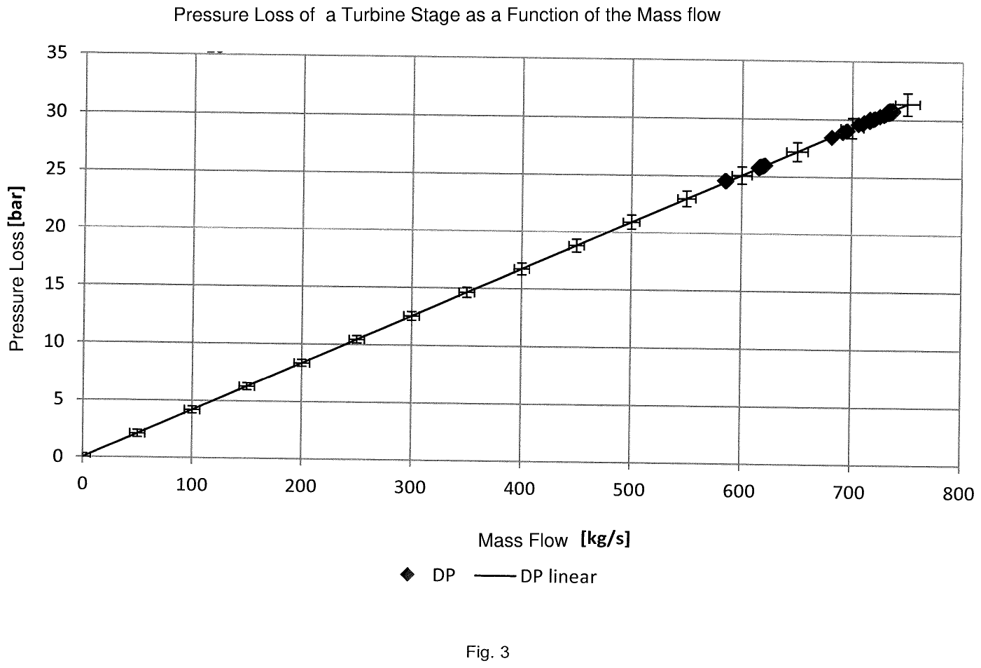

FIGS. 3 to 5 show in an exemplary fashion three different characteristic lines of the plant 1. In this context, validated values are employed so that the mass balances, energy balances, and material balances are indeed closed and do not create any discrepancies.

In FIG. 3, the pressure loss of a turbine stage as a function of mass flow is illustrated. With increasing mass flow, the pressure losses increase.

As an example, the pressure losses have been recorded only in a certain range of the mass flow. The characteristic line has been averaged in relation to the measured values. It extends linearly. The indicated error bars show the possible uncertainties in x direction and y direction.

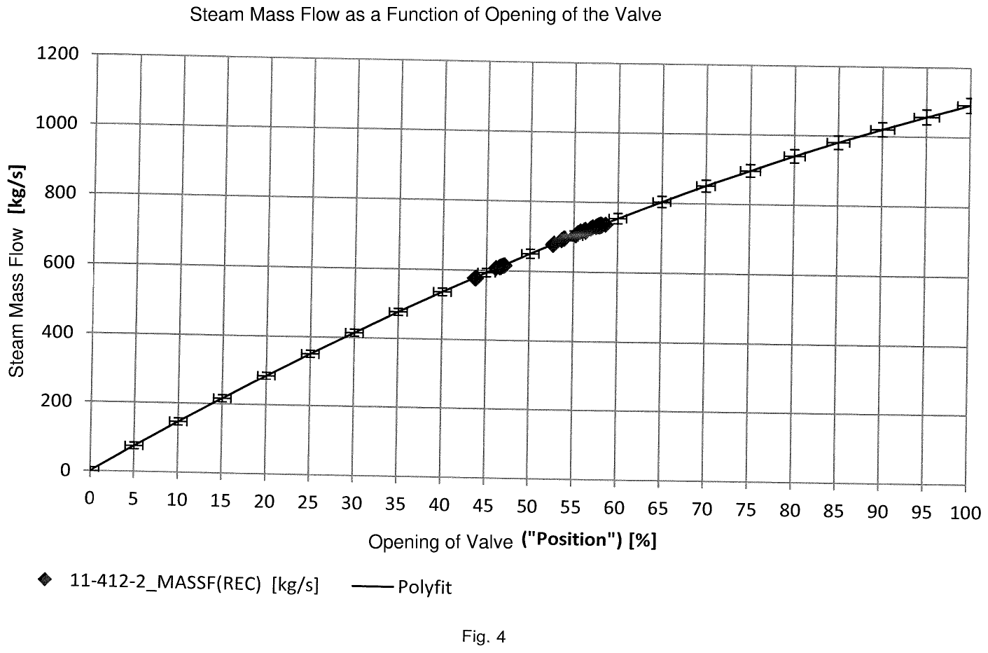

The characteristic line according to FIG. 4 characterizes the steam mass flow as a function of the opening of the valve. In this case also, the steam mass flow has been measured only in a certain opening range of the valve. The remaining portion of the characteristic line has been extrapolated. Here also, the error bars are illustrated that show that uncertainties may occur in x direction and in y direction.

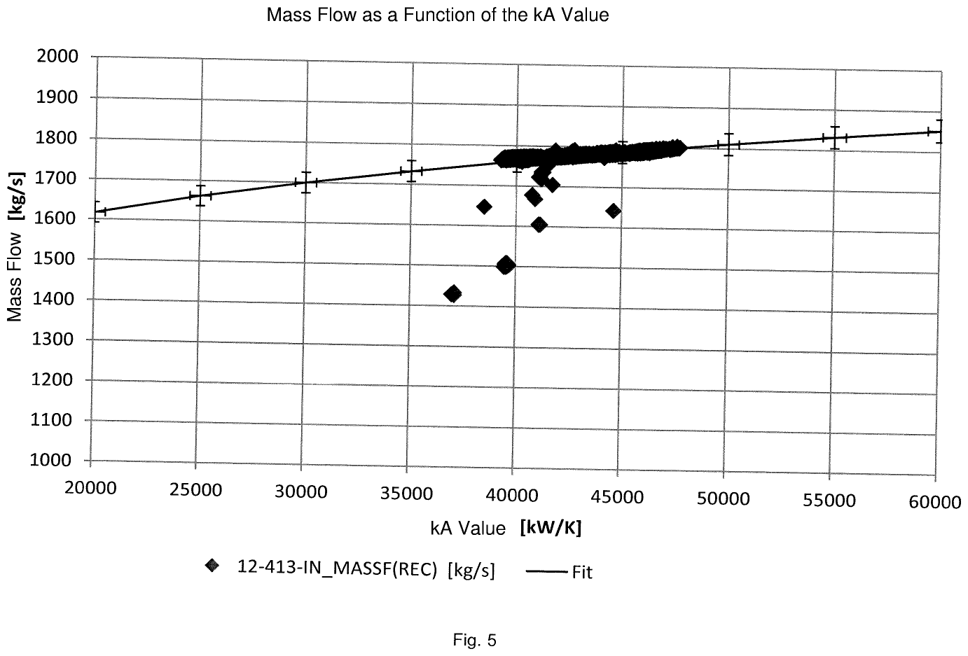

The characteristic line according to FIG. 5 shows the mass flow as a function of the kA value for a heat transfer means. The measurement is done, similar to the preceding examples, only in a certain measuring range. The kA value itself cannot be measured but is calculated based on its operating point from the closed energy balance. The characteristic line has again been extrapolated. The uncertainties in x direction and in y direction are indicated by the error bars.

The characteristic lines are used for so-called what-if scenarios in step 27.

Up to now, the component characteristics of the manufacturers relate to the new state of the plant parts, for example, the pumps, turbines, condensers and the like. The component characteristics of the manufacturers indicate the proper or new state of the components which they no longer have, of course, after an extended time of use of the plant.

With the new simulation method that is performed following the described validation method, the validation model of the process which has been established for this purpose (redundancy>0) is transferred into a simulation model (redundancy=0). In this way, it is ensured that only one model is used for validation according to VDI 2048 and for simulation. With the simulation method, while maintaining all and also individual features, all available measured values and their uncertainties are taken into account. Also, the values of the steam tables that are utilized for determining enthalpies, have uncertainties assigned and are utilized in the calculation.

In this manner, in the described way actual process values that characterize the momentary state of the plant 1 are provided based on which in a further step the actual component characteristics are determined (step 25). They contain already those effects that have been caused, for example, by aging, wear, by abrasion and the like of the plant parts.

Due to the error bars, an uncertainty range is determined which indicates to the plant operator not just a single value but provides him with reliable information with consideration of uncertainties. For the simulation calculation in the what-if strategy, no longer a single characteristic line is utilized, as has been the case in the past, but in addition also an uncertainty range which results from the error propagation of the uncertainties of validated measured values in producing the characteristic line.

Based on the validated process data and the validated component characteristics, a quality-assured simulation and calculation of the what-if scenarios, including the complete evidence of the result uncertainties, is performed. With complete values, component characteristics with uncertainties, and the steam table including its uncertainties, simulation results based on the error propagation calculation are determined which are then present as complete simulation results, wherein the following applies: complete simulation result =absolute value±associated uncertainty.

Since in the new method all measured values, even redundancies, including their uncertainties, are taken into account, the simulations and their results are based on quality-assured sound process data. The results are accordingly designated with uncertainties, which provides significant advantages for the plant operator. Since the plant operator is informed of the uncertainty values, the operator can orient himself based on the lower values of the uncertainties.

In order to obtain the result, in the described manner the actual component behavior is determined because the respective components are measured in the actual state. The quality-assured characteristic lines describe the actual plant state wherein the characteristic lines in addition are provided with uncertainties so that the plant operator can also take deviations into consideration. The same applies also to the process data that are validated according to VDI 2048. They also provide information including uncertainties which enable the plant operator to run the desired what-if scenarios. The steam tables are also provided with the corresponding uncertainties. Furthermore, all process data are quality-assured.

Accordingly, with the component characteristics and the process data, a reliable simulation can be performed that in particular takes into consideration result uncertainties. This is reliably ensured because the input data are quality-assured according to VDI 2048. The measured data show the momentary state of the plant 1 so that these data provide for a sound and reliable basis for a simulation and what-if analyses. The simulation results, which take into account the uncertainties in the component characteristics (characteristic lines) and in the process data, reflect the actual state of the plant so that the operator can perform sound what-if analyses that correspond to reality. The what-if scenarios are performed in order to test, for example, the effect on the efficiency of a plant, on the design of new components and the like. In this connection, for example, a partial load behavior of the process, the influence of internal and external leakages, the evaluation of retrofitting of plant parts, of efficiency increases and the like can be simulated. Since all plant parts are measured and the determined data and components are indicated with the uncertainties, the plant operator is provided with a reliable evaluation of the simulations performed by him. The simulation result enables the operator to reconfigure or adjust as needed his plant in accordance with the simulated conditions.

The specification incorporates by reference the entire disclosure of German priority document 10 2020 004 277.5 having a filing date of Jul. 13, 2020.

While specific embodiments of the invention have been shown and described in detail to illustrate the inventive principles, it will be understood that the invention may be embodied otherwise without departing from such principles.

What is claimed is:

1. A method for simulation of operation/component states of a plant, the method comprising:
measuring process data of the plant components and recording the process data including associated uncertainties of the process data;
subjecting subsequently the process data including the associated uncertainties to a validation to produce validated process data;
determining, based on the validated process data, component characteristics comprising uncertainty values in accordance with the validated process data.

2. The method according to claim 1, further comprising performing a what-if analysis based on the validated process data and the component characteristics.

3. The method according to claim 1, further comprising using steam tables with uncertainty information in the step of measuring.

4. The method according to claim 1, further comprising, for obtaining redundant measured values, performing at least two measurements at the same location in the process or in the plant.
